(19) United States
(12) Patent Application Publication
(10) Pub. No.: US 2026/0081835 A1
(43) Pub. Date: Mar. 19, 2026

(54) SUBSCRIBER ATTRIBUTE BASED USER PLANE FUNCTION (UPF) SELECTION IN WIRELESS COMMUNICATION NETWORKS

(71) Applicant: T-MOBILE INNOVATIONS LLC, Overland Park, KS (US)

(72) Inventors: Rahul Amin, Issaquah, WA (US); Kameswaran Arunachalam, Snohomish, WA (US)

(21) Appl. No.: 18/886,811

(22) Filed: Sep. 16, 2024

(51) Int. Cl. H04L 41/0894; H04W 8/22; H04W 76/10

(52) U.S. Cl. CPC H04L 41/0894; H04W 8/22; H04W 76/10

(57) ABSTRACT

Various embodiments include a system that comprises Session Management Function (SMF). The SMF transfers a policy create request to a Policy Control Function (PCF) in response to receiving a Protocol Data Unit (PDU) session create request for a user device from an Access and Mobility Management Function (AMF). The SMF receives a policy create response for the policy create request from the PCF. The SMF parses the policy create response to determine an application Identifier (ID) for the user device. The SMF maps the application ID to a User Plane Function (UPF) ID. The SMF selects a UPF to serve the user device based on the mapping. The SMF transfers a session request to the UPF to establish a PDU session for the user device.

### TECHNICAL FIELD

Various embodiments of the present technology relate to User Plane Function (UPF) selection, and more specifically, UPF selection based on information received during Session Management Function (SMF)/Policy Control Function (PCF) policy association.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

The network functions in the core network are organized into a control plane and a user plane. The control plane comprises network functions like Access and Mobility Management Function (AMF), Session Management Function (SMF), and Policy Control Function (PCF). The user plane comprises network functions like User Plane Function (UPF). The control plane functions interface with user devices over RANs to establish sessions for the user devices over the user plane. The sessions are referred to as Protocol Data Unit (PDU) sessions. Core networks typically comprise multiple UPFs with varying capabilities. Likewise, the user devices are subscribed for a variety of service types on the core networks. The different service types often comprise different requirements for Quality-of-Service (QoS), latency, throughput, bandwidth, and the like.

In conventional wireless communication networks, user devices are assigned to the UPFs based on UPF load to distribute traffic across the network. This is done to inhibit any one UPF from becoming too heavily loaded. However, load based UPF selection may result in misalignment between the capabilities of UPF and the requirements of a user device's service type. Unfortunately, in some cases, wireless communication networks may not effectively or efficiently select UPFs for user devices.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for User Plane Function (UPF) selection. Some embodiments comprise a method. The method comprises, in response to a Protocol Data Unit (PDU) session create request for a user device received from an Access and Mobility Management Function (AMF), transferring, by a Session Management Function (SMF), a policy create request to a Policy Control Function (PCF). The method further comprises receiving, by the SMF, a policy create response from the PCF for the policy create request. The method further comprises parsing, by the SMF, the policy create response to determine an application Identifier (ID) for the user device. The method further comprises mapping, by the SMF, the application ID to a UPF ID. The method further comprises selecting, by the SMF, a UPF to serve the user device based on the mapping. The method further comprises transferring, by the SMF, a session request to the UPF to establish a PDU session for the user device.

Some embodiments comprise a system. The system comprises an SMF. The SMF transfers a policy create request to a PCF in response to a PDU session create request for a user device received from an AMF. The SMF receives a policy create response from the PCF for the policy create request. The SMF parses the policy create response to determine an application ID for the user device. The SMF maps the application ID to a UPF ID. The SMF selects a UPF to serve the user device based on the mapping. The SMF transfers a session request to the UPF to establish a PDU session for the user device.

Some embodiments comprise one or more non-transitory computer readable storage media having program instructions stored thereon. When executed by a computing system, the program instructions direct the computing system to perform operations. The operations comprise transferring a policy create request to a PCF in response to a PDU session create request for a user device received from an AMF. The operations further comprise receiving a policy create response from the PCF for the policy create request. The operations further comprise parsing the policy create response to determine an application ID for the user device. The operations further comprise mapping the application ID to a UPF ID. The operations further comprise selecting a UPF to serve the user device based on the mapping. The operations further comprise transferring a session request to the UPF to establish a PDU session for the user device.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an example communication network that implements subscriber attribute based User Plane Function (UPF) selection.

FIG. 2 illustrates an exemplary operation of the communication network that implements subscriber attribute based UPF selection.

FIG. 3 illustrates another exemplary operation of the communication network that implements subscriber attribute based UPF selection.

FIG. 4 illustrates an example Fifth Generation (5G) communication network that implements subscriber attribute based UPF selection.

FIG. 5 illustrates an example 5G User Equipment (UE) in the 5G communication network that implements subscriber attribute based UPF selection.

FIG. 6 illustrates an example 5G Radio Access Network (RAN) in the 5G communication network that implements subscriber attribute based UPF selection.

FIG. 7 illustrates network functions in the 5G communication network that implements subscriber attribute based UPF selection.

FIG. 8 illustrates an example Network Function Virtualization Infrastructure (NFVI) in the 5G communication network that implements subscriber attribute based UPF selection.

FIG. 9 further illustrates the NFVI in the 5G communication network that implements subscriber attribute based UPF selection.

FIG. 10 illustrates an exemplary operation of the 5G communication network that implements subscriber attribute based UPF selection.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

In conventional wireless communication networks, the Access and Mobility Management Function (AMF) directs the Session Management Function (SMF) to establish a data session for a user device in response to receiving a session request from the user device. The SMF receives the direction and selects a User Plane Function (UPF) to support the session. Conventional UPF selection relies on a round robin approach to evenly distribute user devices among available UPFs (e.g., available within a given geographic area). This is done to prevent any one UPF from becoming too heavily loaded. However, UPFs often possess varying capabilities. Some UPFs may comprise standard capabilities to support default service to user devices while other UPFs may comprise specialized capabilities to provide specialized service types like low-latency service, high throughput service, high bandwidth service, voice/video conferencing, online gaming, and enhanced security. By using load-based UPF selection, the session requirements for the user devices may become misaligned with the capabilities of the UPFs. For example, a user device that is subscribed to receive low-latency services may be assigned to a default UPF while another user device that is subscribed to receive default service may be assigned to a low-latency capable UPF. This misalignment degrades the overall user experience. As such, conventional wireless communication networks do not effectively or efficiently select UPFs to serve user devices.

To overcome the above-described problems in conventional wireless communication networks, various embodiments of the present technology relate to subscriber attribute based UPF selection. In some examples, the SMF initiates policy association with a Policy Control Function (PCF) in response to receiving a create session request for a user device from the AMF. The PCF selects network policies for the user device based on the user device's subscription on the network. These network policies include an application Identifier (ID). The application ID is a provisioned service value that indicates user plane requirements like Quality-of-Service, latency, throughput, and the like for the user device. The PCF returns the selected network policies to the SMF. The SMF correlates the application ID included in the policies to a UPF in the network and establishes the Protocol Data Unit (PDU) on the selected UPF. This correlation algins the user plane requirements of the user device with the capabilities of the UPF thereby enhancing the overall user experience. Now referring to the Figures.

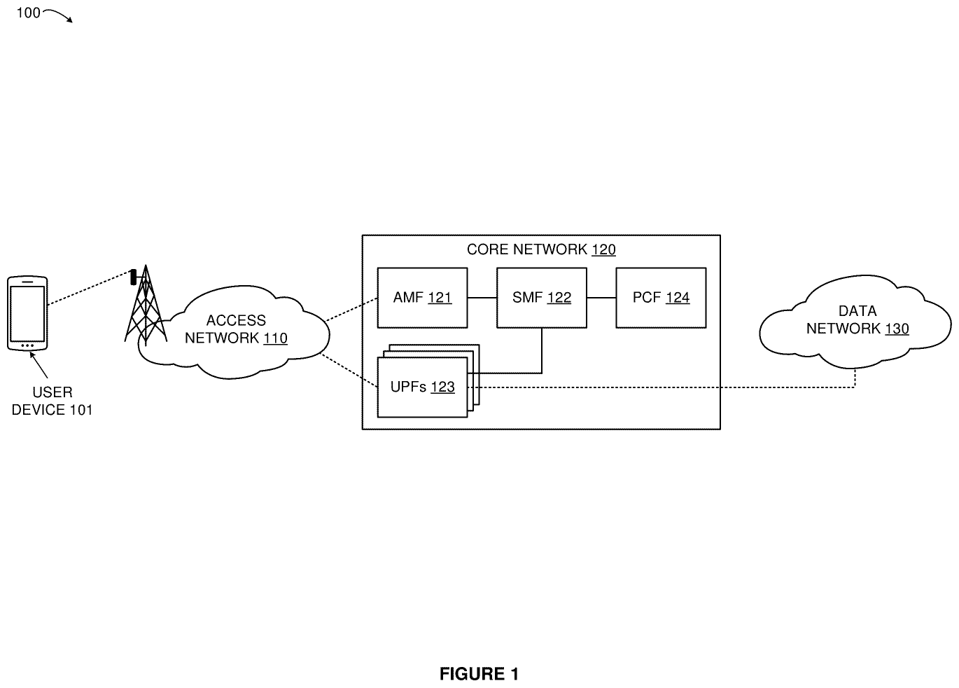

FIG. 1 illustrates communication network 100 to select UPFs based on subscriber attributes. Communication network 100 provides services like media-streaming, internet-access, voice/video calling, text messaging, online gaming, social media, machine communications, or some other wireless communications product. Communication network 100 comprises user device 101, access network 110, core network 120, and data network 130. Core network 120 comprises AMF 121, SMF 122, UPFs 123, and PCF 124. In other examples, communication network 100 may comprise additional or different elements than those illustrated in FIG. 1.

Various examples of network operation and configuration are described herein. In some examples, user device 101 attaches to core network 120 and requests wireless data service. AMF 121 authorizes the request and transfers a PDU session create request for user device 101 to SMF 122. The request directs SMF 122 to organize a PDU session between user device 101 and data network 130 over access network 110 and one of UPFs 123. In response to the PDU session create request received from AMF 121, SMF 122 transfers a policy create request to PCF 124. PCF 124 returns a policy create response to SMF 122. The policy create response includes network policies and/or subscriber attributes of user device 101 that govern PDU sessions of user device 101 over core network 120. In particular, the policy create response includes an application ID. Application ID is a provisioned subscriber attribute that indicates user plane requirements for user devices. For example, the application ID of user device 101 may indicate the traffic characteristics (e.g., Quality-of-Service (QoS)) of service types that user device 101 is authorized to receive. The SMF receives the policy create response and parses the response to determine the application ID for user device 101. SMF 122 maps the application ID to a UPF ID and selects one of UPFs 123 to serve user device 101 based on the mapping. SMF 122 transfers a session request to the selected one of UPFs 123 to establish the PDU session for user device 101. The selected one of UPFs 123 exchanges user data for the PDU session with user device 101 over access network 110 and with data network 130 to serve user device 101.

Advantageously, communication network 100 effectively and efficiently selects UPFs based on subscriber attributes like application ID to serve user devices. Moreover, communication network 100 inhibits misalignment of UPF capabilities and user device traffic characteristics thereby enhancing the overall user experience.

User device 101 comprises a vehicle, drone, robot, computer, phone, sensor, or another type of data appliance with wireless and/or wireline communication circuitry. User device 101 and access network 110 communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WiFi), IEEE 802.3 (Ethernet), Low-Power Wide Area Network (LP-WAN), Bluetooth, and/or some other type of wireless and/or wireline networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Although access network 110 is illustrated as comprising a tower, access network 110 may comprise another type of mounting structure (e.g., a building), or no mounting structure at all. Access network 110 may comprise a Sixth Generation (6G) Radio Access Network (RAN), Fifth Generation (5G) RAN, LTE RAN, gNodeB, eNodeB, Narrow Band Internet-of-Things (NB-IoT) access node, trusted non-Third Generation Partnership Project (3GPP) access node, untrusted non-3GPP access node, Low Power-Wide Area Network (LP-WAN) base station, wireless relay, WiFi hotspot, Bluetooth access node, Ethernet access node, and/or another type of wireless or wireline network transceiver. Access network 110 exchanges network signaling and user data with network functions clustered together into core network 120. Access network 110 is connected to core network 120 over backhaul data links. Access network 110 and core network 120 may communicate via edge networks like internet backbone providers, edge computing systems, or another type of edge system to provide the backhaul data and signaling links between access network 110 and core network 120.

Access network 110 may comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in core network 120.

Core network 120 is representative of computing systems that provide wireless data services to user device 101 over access network 110. Exemplary computing systems comprise Network Function Virtualization Infrastructure (NFVI) systems, data centers, server farms, cloud computing networks, hybrid cloud networks, and the like. Core network 120 may comprise a 3GPP core network architecture like Sixth Generation Core (6GC), Fifth Generation Core (5GC), Evolved Packet Core (EPC), and/or another type of 3GPP core network architecture. Access network 110, core network 120, and data network 130 communicate over various links that use metallic links, glass fibers, radio channels, or some other communication media. The links use 6GC, 5GC, EPC, Ethernet, Time Division Multiplex (TDM), Data Over Cable System Interface Specification (DOCSIS), Internet Protocol (IP), General Packet Radio Service Transfer Protocol (GTP), 6GR, 5GNR, LTE, WiFi, virtual switching, inter-processor communication, bus interfaces, and/or some other data communication protocols. The computing systems of core network 120 store and execute the network functions/entities to form AMF 121, SMF 122, UPFs 123, and PCF 124. The network functions are typically organized into a control plane and a user plane. The control plane may comprise network functions like AMF 121, SMF 122, PCF 124, as well as other network functions like Authentication Server Function (AUSF), Unified Data Management (UDM), Unified Data Registry (UDR), and the like. The user plane may comprise network functions like UPFs 123 and the like.

Data network 130 comprises an Application Server (AS) that hosts applications (e.g., media streaming applications, social media applications, IoT applications, online gaming applications, etc.) for user device 101. Data network 130 may be representative of a public data network (e.g., the Internet) or a private data network (e.g., an enterprise network). Core network 120 and data network 130 may communicate via links provided by internet backbone providers, edge computing services, and/or other communication services that provide the data links between core network 120 and data network 130.

User device 101 and access network 110 comprise antennas, amplifiers, filters, modulation, analog/digital interfaces, microprocessors, software, memories, transceivers, bus circuitry, and the like. User device 101, access network 110, core network 120, and data network 130 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), Analog Processing Units (APUs), and/or the like. The memories comprise Random Access Memory (RAM), Solid State Drives (SSDs), Hard Disk Drives (HDDs), Non-Volatile Memory Express (NVMe) SSDs, and/or the like. The memories store software like operating systems, user applications, radio applications, and network functions. The microprocessors retrieve the software from the memories and execute the software to drive the operation of communication network 100 as described herein.

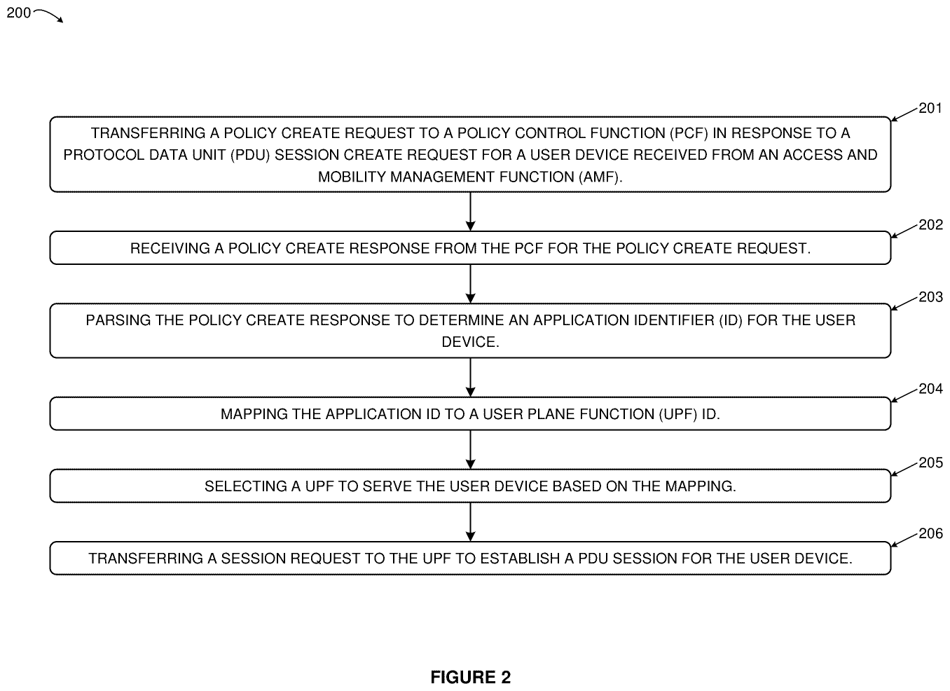

FIG. 2 illustrates process 200. Process 200 comprises an exemplary operation of communication network 100 to select UPFs based on subscriber attributes. Process 200 may vary in other examples. The operations of process 200 comprise transferring a policy create request to a PCF in response to a PDU session create request for a user device received from an AMF (step 201). The operations further comprise receiving a policy create response from the PCF for the policy create request (step 202). The operations further comprise parsing the policy create response to determine an application ID for the user device (step 203). The operations further comprise mapping the application ID to a UPF ID (step 204). The operations further comprise selecting a UPF to serve the user device based on the mapping (step 205). The operations further comprise transferring a session request to the UPF to establish a PDU session for the user device (step 206).

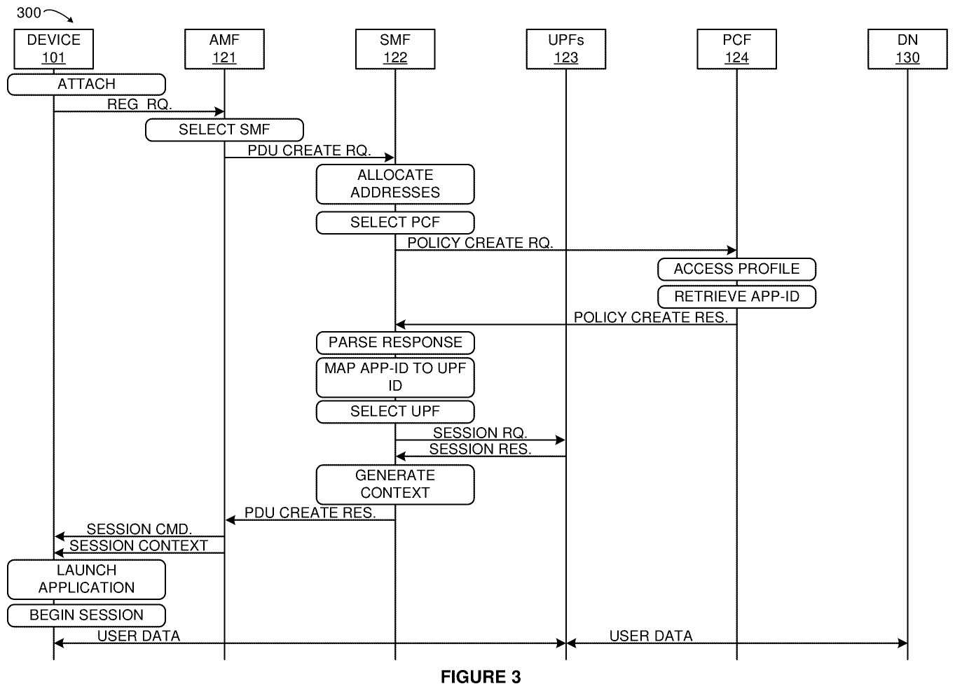

FIG. 3 illustrates process 300. Process 300 comprises an exemplary operation of communication network 100 to select UPFs based on subscriber attributes. Process 300 comprises an example of process 200 illustrated in FIG. 2, however process 200 may differ. Process 300 may vary in other examples. In some examples, user device 101 attaches to core network 120 over access network 110. User device 101 transfers a registration request (REG RQ.) to AMF 121 in core network 120. The registration request includes information like subscriber ID, device capabilities, PDU session request requests, and the like. AMF 121 authenticates user device 101 and authorizes user device 101 for service on communication network 100. Responsive to authentication and authorization, AMF 121 selects SMF 122 to serve user device 101 and transfers a PDU create session request (RQ.) to SMF 122 to establish the PDU session requested by user device 101.

SMF 122 receives the request from AMF 121 and allocates Internet Protocol (IP) addresses and a Tunnel End Point ID (TEID) for the session. SMF 122 selects PCF 124 to create a policy association for the PDU session. SMF 122 transfers a policy create request to PCF 124 to retrieve network policies for the session. Exemplary network policies include QoS rules, traffic forwarding/treatment policies, User Equipment Route Selection Policy (URSP) rules, application IDs, and the like. PCF 124 accesses the subscriber profile of user device 101 stored by a network data system (e.g., a UDR) and selects network policies based on the subscriber attributes. In particular, PCF 124 selects an application ID for the PDU session based on the subscriber attributes. For example, if the subscriber attributes indicate user device 101 is provisioned for low-latency service, PCF 124 may select an application ID for low-latency service. Exemplary application IDs include low-latency service IDs, high-throughput IDs, gaming IDs, media streaming IDs, media broadcasting IDs, Virtual Reality (VR)/Extended Reality (XR) IDs, enhanced security IDs, voice/video conferencing IDs, internet access IDs, default service IDs, and the like. PCF 124 returns a policy create response (RES.) to SMF 122 that includes the selected network policies and subscriber attributes, including any application IDs selected for user device 101.

SMF 122 receives and parses the policy create response to read the application IDs, network policies, and/or other data included in the response. For example, the message header of the response may include one or more application IDs and SMF 122 may parse the message header to determine the application IDs for user device 101. SMF 122 hosts a data structure that correlates application IDs to UPF IDs. The data structure associates provisioned service types (as indicated by the application IDs) to UPFs that support the service types. For example, the data structure may associate an application ID for online gaming with a UPF ID for one of UPFs 123 with capabilities tailored for online gaming. SMF 122 inputs the application ID(s) read from the policy create response into the data structure which outputs a corresponding UPF ID. SMF 122 selects one of UPFs 123 based on the UPF ID.

SMF 122 transfers a create session request to the selected one of UPFs 123. The selected one of UPFs 123 sets up a default bearer to support the session and returns a create session response to SMF 122 confirming bearer creation. SMF 122 generates session context that includes the session IP address, TEID, UPF addresses, and/or other data for user device 101 to begin the PDU session. SMF 122 transfers a PDU create session response to AMF 121 confirming session creation and that includes the session context. AMF 121 controls access network 110 to support the PDU session. AMF 121 transfers a session command (CMD.) and the session context to user device 101 over access network 110. The session command directs user device 101 to begin the PDU session. User device 101 launches a user application and begins the PDU session. User device 101 exchanges user data with the selected one of UPFs 123 based on the session context. The selected one of UPFs 123 exchanges the user data with data network 130.

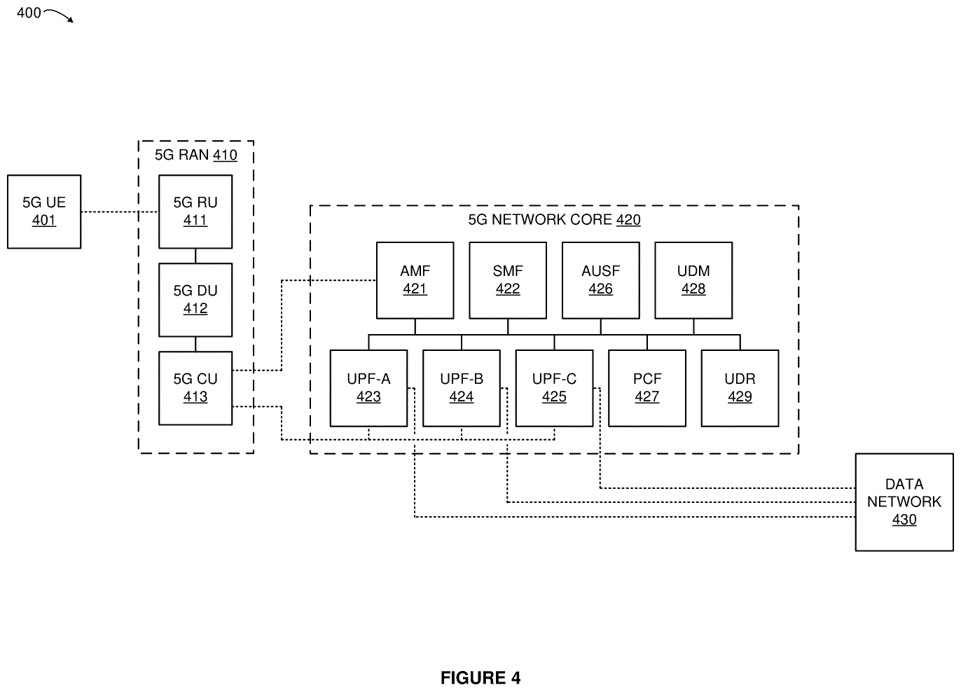

FIG. 4 illustrates 5G communication network 400 to select UPFs based on Traffic Detection Functionality (TDF) application ID. 5G communication network 400 comprises an example of communication network 100 illustrated in FIG. 1, however communication network 100 may differ. 5G communication network 400 comprises 5G User Equipment (UE) 401, 5G RAN 410, 5G network core 420, and data network 430. 5G RAN 410 comprises 5G RU 411, 5G DU 412, and 5G CU 413. 5G network core 420 comprises AMF 421, SMF 422, UPF-A 423, UPF-B 424, UPF-C 425, AUSF 426, PCF 427, UDM 428, and UDR 429. Other network functions and network entities like Network Slice Selection Function (NSSF), Charging Function (CHF), Home Subscriber Register (HLR), Home Subscriber Server (HSS), Network Repository Function (NRF), Short Message Service Function (SMSF), Network Exposure Function (NEF), Application Function (AF), Equipment Identity Register (EIR), and Session Communication Proxy (SCP) are typically present in 5G network core 420 but are omitted for clarity. In other examples, 5G communication network 400 may comprise different or additional elements than those illustrated in FIG. 4.

In some examples, UE 401 wirelessly attaches to 5G RAN 410 over a 5GNR link. UE 401 undergoes a Random Access Channel (RACH) procedure with 5G RAN 410 to establish a secure signaling channel. UE 401 transfers a registration request to AMF 421 over 5G RAN 410. The registration request indicates a registration type, 5G-Global Unique Temporary Identifier (GUTI), Tracking Area Identifier (TAI), Network Slice Selection Assistance Information (NSSAI) requests, UE capabilities, PDU session requests, and the like.

In response to the registration request, AMF 421 transfers a Non-Access Stratum (NAS) identity request to UE 401 over a NAS signaling link between UE 401 and AMF 421 that traverses 5G RAN 410. UE 401 indicates its Subscriber Concealed Identifier (SUCI) to AMF 421 over the NAS link that traverses 5G RAN 410. AMF 421 transfers an authentication request to AUSF 426 to retrieve authentication vectors to authenticate UE 401. The request comprises the SUCI for UE 401. AUSF 426 indicates the SUCI and requests authentication vectors from UDM 428. UDM 428 accesses the subscriber profile for UE 401 stored on UDR 429 and derives the Subscriber Permanent Identifier (SUPI) for UE 401 based on the SUCI. UDM 428 generates authentication vectors for UE 401 and returns the vectors and SUPI to AUSF 426. The authentication vectors comprise a random number, expected result, key selection criteria, and the like. AUSF 426 forwards the SUPI and authentication vectors to AMF 421. AMF 421 transfers an authentication challenge that comprises the random number and key selection criteria to UE 401 over the NAS link that traverses 5G RAN 410. UE 401 hashes random number with its secret key to generate an authentication result and indicates the authentication result to AMF 421 over the NAS link. AMF 421 matches the expected result retrieved from AUSF 426 with the authentication result received from UE 401 to authenticate UE 401.

Responsive to the authentication, AMF 421 transfers a context registration request to UDM 428 that includes AMF ID, a supported feature list, a Permanent Equipment Identifier (PEI) for UE 401, and the like. UDM 428 indicates successful UDM registration to AMF 421. In response, AMF 421 requests access and mobility subscription data, SMF selection subscription data, and UE context in SMF data from UDM 428. UDM 428 accesses the subscriber profile for UE 401 stored by UDR 429 and returns the requested data. The access and mobility subscription data comprises a supported feature list for UE 401 (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list, and a list of allowed S-NSSAIs and associated information. The UE context in SMF data comprises PDU session and EPC interworking information. AMF 421 forms the UE context for UE 401 using the retrieved information. The UE context defines the authorized services for UE 401.

AMF 421 transfers a policy creation request to PCF 427 to create a policy association for UE 401. PCF 427 responds to the request with policy association information like the SUPI, GPSI, PEI, and user location information for UE 401. PCF 427 subscribes to AMF 421 for event reporting like user location updates, registration state changes, communication failure events, and the like. AMF 421 creates a PCF subscription based on the policy association information and signals PCF 427 of the successful subscription creation.

AMF 421 selects SMF 422 to serve UE 401 based on SMF selection data received from UDM 428, the network policies received from PCF 427, and/or the network slice assigned to UE 401. AMF 421 transfers a list of requested PDU sessions (as received during the registration request), a PDU session activation command, and the SUPI to SMF 422. SMF 422 receives the PDU session list, session activation command, and the SUPI from AMF 421. SMF 422 allocates IP addresses to UE 401 for the requested PDU sessions and allocates a TEID for the session. SMF 422 transfers session management policy creation request to PCF 427 to create a session management policy association for UE 401. PCF 427 accesses UE 401's subscriber profile stored by UDR 429 to select session management policies based on the subscriber attributes stored in the profile. PCF 427 selects TDF application ID, QoS rules, traffic treatment rules, traffic forwarding rules, URSP rules, and the like. PCF 427 transfers a session management policy creation response that includes the selected network policies. PCF 427 subscribes to SMF 422 for event reporting like PDU session start/termination, PDU session modification, UPF change, and the like. SMF 422 creates a PCF subscription based on the policy association information and signals PCF 427 of the successful subscription creation.

SMF 422 parses the session management policy creation response to read the TDF application ID included in the response. The TDF application ID indicates the traffic type(s) UE 401 is provisioned for. Exemplary TDF application IDs include low-latency service IDs, high-throughput IDs, gaming IDs, media streaming IDs, media broadcasting IDs, Virtual Reality (VR)/Extended Reality (XR) IDs, enhanced security IDs, voice/video conferencing IDs, internet access IDs, and the like. The TDF application ID may be included in the message header or message body of the policy creation response.

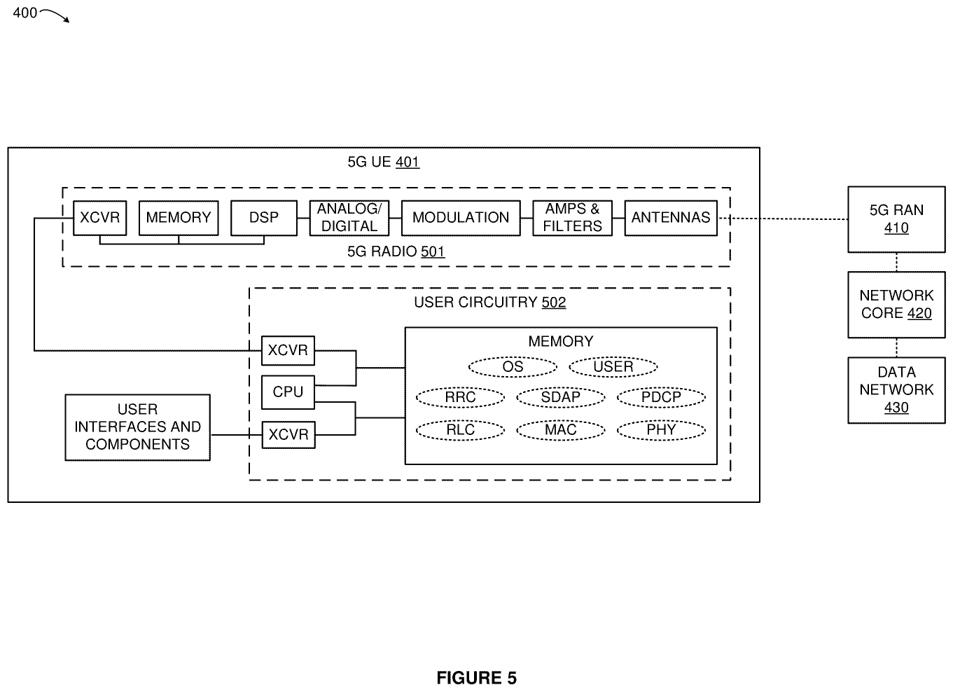

SMF 422 hosts a data structure that correlates TDF application IDs to UPF-IDs to associate provisioned/authorized traffic types for UE 401 with UPF capabilities. The UPF-IDs indicate UPFs instantiated in 5G network core 420 (e.g., UPFs 423-425). SMF 422 utilizes the data structure to select a UPF best suited to serve the traffic types that UE 401 is authorized to receive. As illustrated in FIGS. 4, 5G network core 420 includes UPF-A 423, UPF-B 424, and UPF-C 425. UPFs 423-425 are representative of UPFs with different capabilities. For example, UPF-A 423 may comprise capabilities to support low-latency sessions, UPF-B 424 may comprise capabilities to support high-throughput sessions, and UPF-C 425 may comprise default capabilities to support generic internet access. Other exemplary UPF capabilities include gaming, media streaming, media broadcasting, voice/video conferencing, remote device control, enhance security, and the like. 5G network core 420 typically comprises more UPFs than illustrated in FIG. 4.

SMF 422 inputs the TDF application ID parsed from the policy create response into the data structure which outputs a corresponding UPF ID. SMF 422 selects one of UPFs 423-425 based on the UPF-ID. SMF 422 transfers a session modification request that includes a session endpoint identifier, IP address, MSISDN, session start/stop information, and TEID to the selected one of UPFs 423-425 to set up the PDU sessions for UE 401. The selected one of UPFs 423-425 sets up a default bearer for UE 401 that traverses 5G RAN 410. The default bearer is a link to carry IP packets for UE 401's PDU session. In some examples, UE 401 may not be provisioned with a TDF application ID. In such examples, SMF 422 parses the policy create response and determines TDP application ID is not present. In response, SMF 422 forgoes application ID based UPF selection and instead assigns UE 401 to a UPF with default capabilities based on factors like load, geolocation, and the like.

SMF 422 returns a PDU session create response to AMF 421 to confirm session creation. In response, AMF 421 registers UE 401 for service on 5G network core 420. AMF 421 generates a registration accept message that includes the allocated UE IP address, RAN ID, AMBR, Globally Unique AMF ID (GUAMI), PDU session ID, PDU session TEID, allowed NSSAI list, security data, and the like. AMF 421 transfers the registration accept message to UE 401 over the NAS link that traverses 5G RAN 410. UE 401 receives the registration accept message. UE 401 receives a user input launching a user application and directs the user application to begin the PDU session based on the registration accept message. The application generates user data. UE 401 wirelessly exchanges the user data for the PDU session with the selected one of UPFs 423-425 over the default bearer that traverses 5G RAN 410 based on the URSP rules provided by PCF 427. The selected one of UPFs 423-425 exchanges the user data with data network 430.

FIG. 5 illustrates UE 401 in 5G communication network 400. UE 401 comprises an example of user device 101 illustrated in FIG. 1, although user device 101 may differ. UE 401 comprises 5G radio 501 and user circuitry 502. 5G radio 501 comprises 5GNR antennas, amplifiers, filters, modulation, analog-to-digital interfaces, Digital Signal Processers (DSP), memory, and transceivers (XCVRs) that are coupled over bus circuitry. User circuitry 502 comprises memory, CPU, user interfaces and components, and transceivers that are coupled over bus circuitry.

The memory in user circuitry 502 stores an operating system (OS), user applications (USER), and 5GNR network applications for PHY, MAC, RLC, PDCP, SDAP, and RRC. The antenna in 5G radio 501 is wirelessly coupled to 5G RAN 410 over a 5GNR link. Transceivers in radio 501 are coupled to a transceiver in user circuitry 502. A transceiver in user circuitry 502 is typically coupled to user interfaces and components like displays, controllers, and memory.

In 5G radio 501, the antennas receive wireless signals from 5G RAN 410 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 502 over the transceivers. In user circuitry 502, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In 5G radio 501, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 410 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving, Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs).

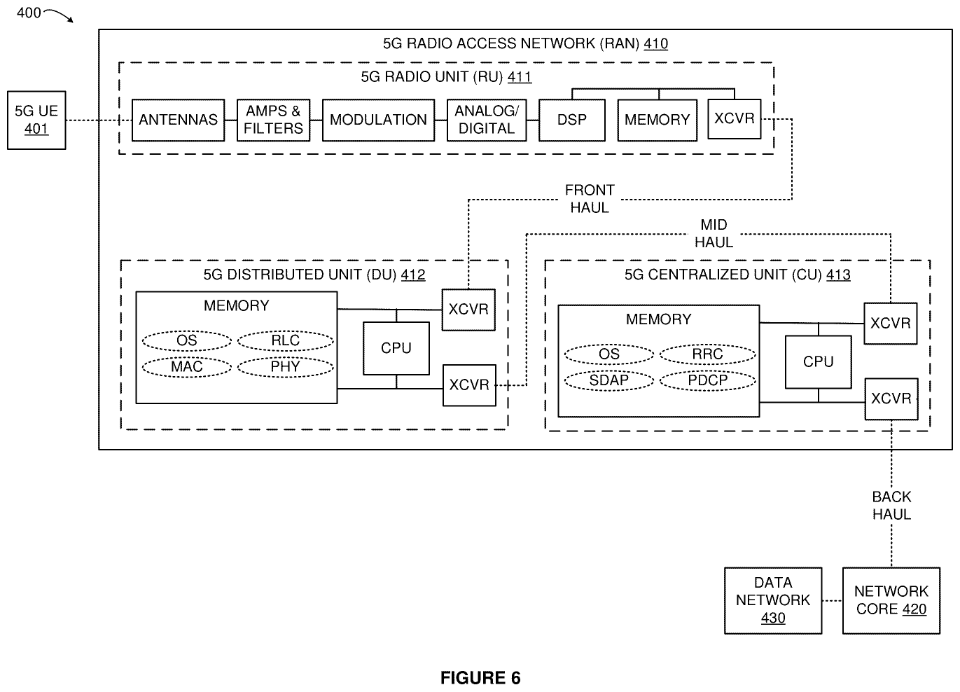

FIG. 6 illustrates 5G RAN 410 in 5G communication network 400. 5G RAN 410 comprises an example of the access network 110 illustrated in FIG. 1, although access network 110 may differ. RU 411 comprises 5GNR antennas, amplifiers, filters, modulation, analog-to-digital interfaces, DSP, memory, and transceivers (XCVRs) that are coupled over bus circuitry. UE 401 is wirelessly coupled to antennas in RU 411 over 5GNR links. Transceivers in RU 411 are coupled to transceivers in DU 412 over fronthaul links like enhanced Common Public Radio Interface (eCPRI). The DSPs in RU 411 executes their operating systems and radio applications to exchange 5GNR signals with UE 401 and to exchange 5GNR data with DU 412.

For the uplink, the antennas in RU 411 receive wireless signals from UE 401 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 412 over the transceivers.

For the downlink, the DSPs receive downlink 5GNR symbols from DU 412. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 401 that transport the downlink 5GNR signaling and data.

DU 412 comprises memory, CPU, and transceivers that are coupled over bus circuitry. The memory in DU 412 stores operating systems and 5GNR network applications like PHY, MAC, and RLC. CU 413 comprises memory, CPU, and transceivers that are coupled over bus circuitry. The memory in CU 413 stores an operating system and 5GNR network applications like PDCP, SDAP, and RRC. Transceivers in DU 412 are coupled to transceivers in RU 411 over front-haul links. Transceivers in DU 412 are coupled to transceivers in CU 413 over mid-haul links. A transceiver in CU 413 is coupled to 5G network core 420 over backhaul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

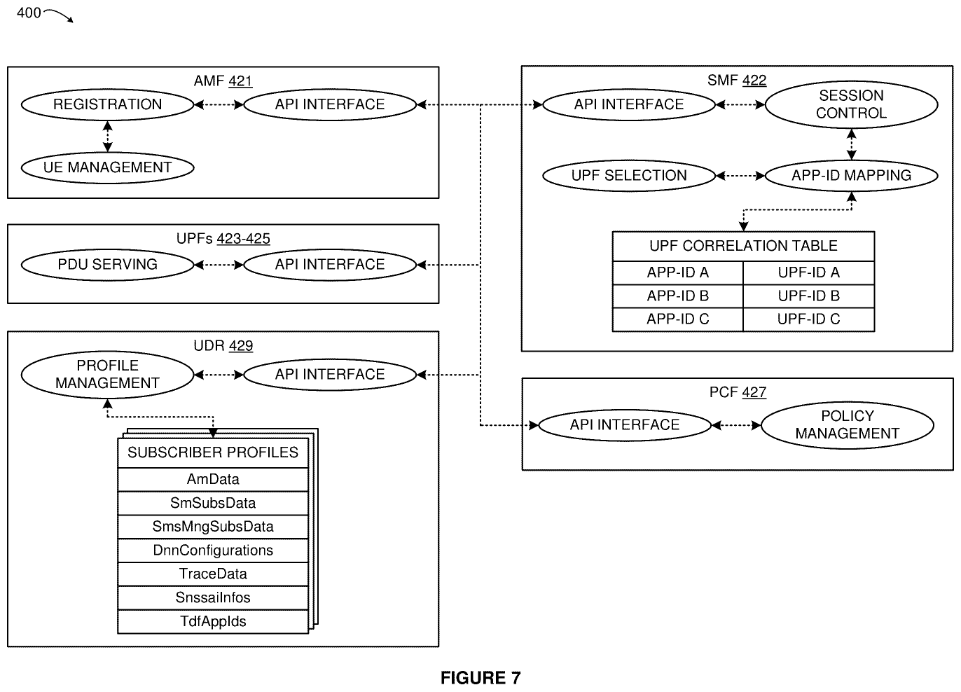

FIG. 7 illustrates AMF 421, SMF 422, UPFs 423-425, PCF 427, and UDR 429 in 5G communication network 400. In some examples, the network functions illustrated in FIG. 7 each comprise an API interface. The API interfaces allow the network functions to communication with each other and with external systems like 5G RAN 410, UE 401, and data network 430. AMF 421 comprises modules for UE registration and UE connection and mobility and management. The registration module handles registration signaling, authentication, and authorization. The management module controls mobility handover and connection teardown/setup. SMF 422 comprises modules for session control, application-ID mapping, and UPF selection, and stores a UPF correlation table. The session control module comprises capabilities for session setup, session termination, session management, session authorization, and address allocation. The application-ID mapping module comprises capabilities for policy create response message parsing and TDF application-ID/UPF-ID mapping. The UPF selection module comprises capabilities for UPF-ID based UPF selection. The UPF correlation table associates TDF application IDs with corresponding UPF IDs. The application-ID module compares TDF application IDs parsed from policy create responses to the table to determine UPF-IDs for the UPF selection module. This correlates the service types that UE 401 is provisioned to receive with a UPF that has capabilities to support these service types.

UPFs 423-425 comprise modules for PDU serving. The PDU serving module comprises capabilities for packet routing, packet forwarding, QoS handling, and PDU serving. PCF 427 comprises modules for policy management. The policy management module selects and enforces policies for UE 401 on 5G network core 420 based on subscriber attributes stored in UE 401's subscriber profile. UDR 429 comprises modules for subscriber profile management and stores subscriber profiles for UEs on 5G communication network 400, including the subscriber profile of UE 401. The profile management module comprises capabilities for reading/writing data to the subscriber profiles. The subscriber profiles store subscriber attributes that define authorized services for UEs 5G communication network 400. The subscriber attributes comprise access and mobility data (AmData), session management subscription data (SmSubsData), Short-Message-Service (SMS) management subscription data (SmsMngSubsData), Data Network Name (DNN) configurations (Dnnconfigurations), trace data (TraceData), Single-NSSAI information (SnssaiInfos), and TDF Application IDs (TdfAppIds).

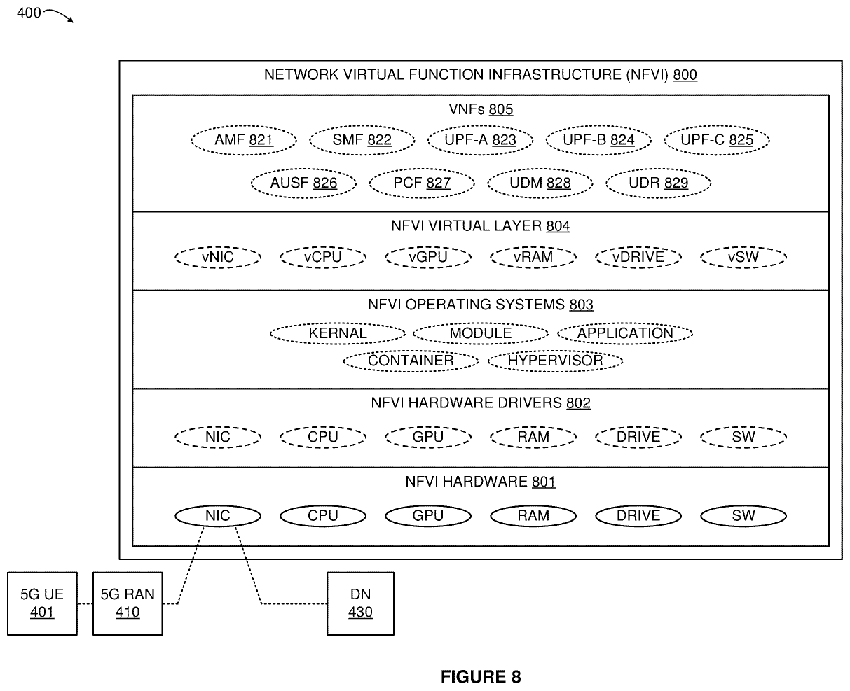

FIG. 8 illustrates NFVI 800 in 5G communication network 400. NFVI 800 comprises an example of core network 120 illustrated in FIG. 1, although core network 120 may differ. NFVI 800 comprises NFVI hardware 801, NFVI hardware drivers 802, NFVI operating systems 803, NFVI virtual layer 804, and NFVI Virtual Network Functions (VNFs)/Cloud-Native Network Functions (CNFs) 805. NFVI hardware 801 comprises Network Interface Cards (NICs), CPU, GPU, RAM, Flash/Disk Drives (DRIVE), and Data Switches (SW). NFVI hardware drivers 802 comprise software that is resident in the NIC, CPU, GPU, RAM, DRIVE, and SW. NFVI operating systems 803 comprise kernels, modules, applications, containers, hypervisors, and the like. NFVI virtual layer 804 comprises vNIC, vCPU, vGPU, vRAM, vDRIVE, and vSW. NFVI VNFs/CNFs 805 comprise AMF 821, SMF 822, UPFs 823-825, AUSF 826, PCF 827, UDM 828, and UDR 829. Additional VNFs/CNFs like NSSF, CHF, HLR, HSS, NRF, SMSF, NEF, AF, EIR, and SCP are typically present but are omitted for clarity. NFVI 800 may be located at a single site or be distributed across multiple geographic locations. The NIC in NFVI hardware 801 is coupled to 5G RAN 410, data network 430, and to external systems (not illustrated). NFVI hardware 801 executes NFVI hardware drivers 802, NFVI operating systems 803, NFVI virtual layer 804, and NFVI VNFs/CNFs 805 to form AMF 421, SMF 422, UPFs 423-425, AUSF 426, PCF 427, UDM 428, and UDR 429.

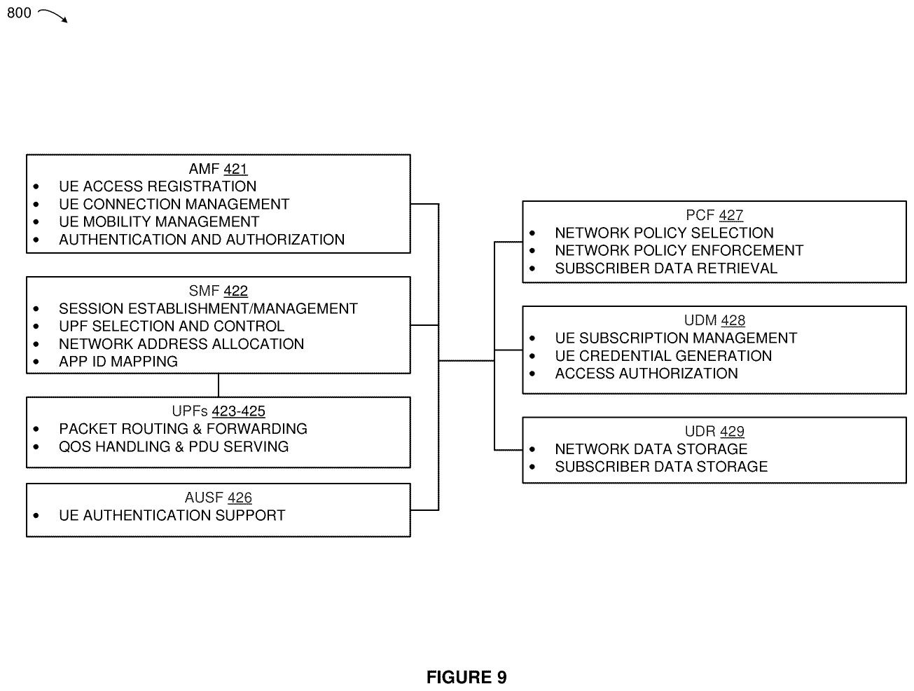

FIG. 9 further illustrates NFVI 800 in 5G communication network 400. AMF 421 comprises capabilities for UE registration, UE connection management, UE mobility management, authentication, and authorization. SMF 422 comprises capabilities for session establishment, session management, UPF selection, UPF control, network address allocation, and application ID mapping. UPFs 423-425 comprise capabilities for packet routing, packet forwarding, QoS handling, and PDU serving. AUSF 426 comprises capabilities for UE authentication support. PCF 427 comprises capabilities for network policy selection, network policy enforcement, and subscriber data retrieval. UDM 428 comprises capabilities for UE subscription management, UE credential generation, and access authorization. UDR 429 comprises capabilities for network data storage and subscriber data storage.

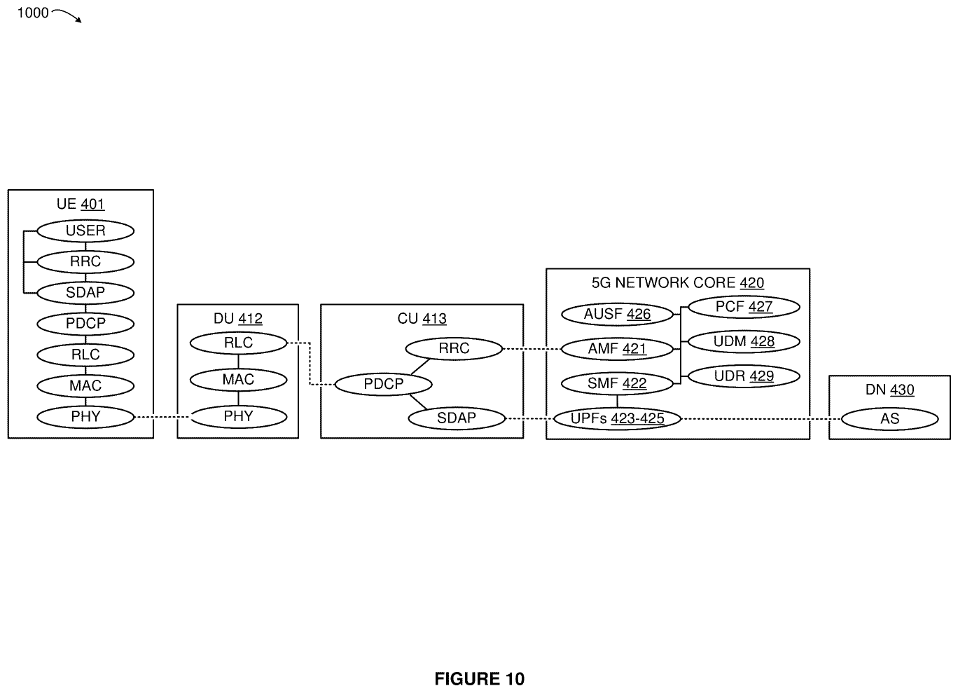

FIG. 10 illustrates process 1000. Process 1000 comprises an exemplary operation of 5G communication network 400 to select UPFs based on TDF application ID. Process 1000 comprises an example of processes 200 and 300 illustrated in FIGS. 2 and 3, however processes 200 and 300 may differ. Process 1000 may vary in other examples. In some examples, UE 401 attaches to RAN 410 over RU 411. The RRC in UE 401 transfers a registration request to the RRC in CU 413 over the PDCPs, RLCs, MACs, and PHYs. The RRC in CU 413 forwards the request to AMF 421. In response, AMF 421 transfers and identity request for UE 401 in NAS signaling to the RRC in CU 413. The RRC forwards the identity request to the RRC in UE 401 over the PDCPs, RLCs, MACs, and PHYs. The RRC in UE 401 returns an identity indication (e.g., SUCI) to the RRC in CU 413 over the PDCPs, RLCs, MACs, and PHYs. The RRC in CU 413 forwards the identity indication to AMF 421. AMF 421 interfaces with AUSF 426, UDM 428, and UE 401 to verify the identity of UE 401.

Responsive to the authentication, AMF 421 interfaces with PCF 427 and UDM 428 to determine authorized services and select network policies for UE 401. UDM 428 accesses UE 401's subscriber profile and returns access and mobility subscription data, SMF selection subscription data, and UE context in SMF data to AMF 421. PCF 427 accesses UE 401's subscriber profile and returns policy association information like the SUPI, GPSI, PEI, and user location information for UE 401 to AMF 421. AMF 421 forms the UE context for UE 401 using the received information.

AMF 421 selects SMF 422 to serve UE 401 based on SMF selection data. AMF 421 transfers a list of requested PDU sessions, a PDU session activation command, and the SUPI to SMF 422. SMF 422 allocates IP addresses and TEID for the session. SMF 422 transfers session management policy creation request to PCF 427 to create a session management policy association for UE 401. PCF 427 accesses UE 401's subscriber profile stored by UDR 429 and select session management policies based on the subscriber attributes stored in the profile. The selected policies include a TDF application ID for online gaming service. PCF 427 transfers a session management policy creation response that includes the selected network policies to SMF 422. SMF 422 parses the session management policy creation response to read the TDF application ID included in the response. SMF 422 inputs the TDF ID into its UPF correlation table which outputs a UPF-ID for UPF-A 423. In this example, UPF-A 423 comprises capabilities to support online gaming sessions (e.g., capabilities to support high QoS, low-latency, and low jitter traffic). SMF 422 selects UPF-A 423 to serve the PDU based on the UPF-ID output from the correlation table. SMF 422 transfers a session modification request that includes a session endpoint identifier, IP address, session start/stop information, and TEID to UPF-A 423 to set up the PDU sessions for UE 401. UPF-A 423 sets up a default bearer for the PDU session and notifies SMF 422 of the successful bearer setup.

SMF 422 transfers a PDU session create response to AMF 421 to confirm session creation. In response, AMF 421 registers UE 401 for service on 5G network core 420. AMF 421 generates a registration accept message that includes the UE context, addresses, network policies, and/or other information for UE 401 to receive service over RAN 410. AMF 421 transfers the registration accept message to the RRC in CU 413. The RRC in CU 413 forwards the registration accept message to the RRC in UE 401. UE 401 receives a user input that launches an online gaming user application. In response, the RRC in UE 401 directs the SDAP in UE 401 to begin the PDU session. The gaming application generates uplink data for the PDU session and the SDAP transfers the uplink data to the SDAP in CU 413 over the PDCPs, RLCs, MACs, and PHYs. The SDAP transfers the uplink data to UPF-A 423 which in turn routes the uplink data to the AS in data network 430. The AS in data network 430 generates downlink data for the PDU session and transfers the downlink data to UPF-A 423. UPF-A 423 forwards the downlink data to the SDAP in CU 413. The SDAP in CU 413 delivers the downlink data to the SDAP in UE 401 over the PDCPs, RLCs, MACs, and PHYs.

The wireless data network circuitry described above comprises computer hardware and software that form special-purpose network circuitry to select UPFs based on subscriber attributes. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to select UPFs based on subscriber attributes.

Although the descriptions provided herein may be in the context of certain radio access technologies, networks, and network topologies, such as 5GNR mobile communications, the proposed concepts, schemes, and any variations thereof may be implemented in, for and by other types of radio access technologies, networks, and network topologies. Such radio access technologies, networks, and network topologies may include, for example and without limitation, LTE, Internet-of-Things (IoT), NB-IoT, Vehicle-to-Everything (V2X), fixed wireless internet, and Non-Terrestrial Network (NTN) communications. Thus, the scope of the disclosure is not limited to the examples described herein.

The above description and associated figures teach the best mode of the invention. For the purpose of teaching inventive principles, some conventional aspects of the best mode may be simplified or omitted. The following claims specify the scope of the invention. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described above, nor the best mode, but only by the claims and their equivalents.

What is claimed is:

1. A method comprising:
in response to a Protocol Data Unit (PDU) session create request for a user device received from an Access and Mobility Management Function (AMF), transferring, by a Session Management Function (SMF), a policy create request to a Policy Control Function (PCF);
receiving, by the SMF, a policy create response from the PCF for the policy create request;
parsing, by the SMF, the policy create response to determine an application Identifier (ID) for the user device;
mapping, by the SMF, the application ID to a User Plane Function (UPF) ID;
selecting, by the SMF, a UPF to serve the user device based on the mapping; and
transferring, by the SMF, a session request to the UPF to establish a PDU session for the user device.

2. The method of claim 1 wherein mapping the application ID to the UPF ID comprises hosting, by the SMF, a data structure that associates application IDs with UPF IDs, comparing the application ID to the data structure, and selecting the UPF ID based on the comparison.

3. The method of claim 1 wherein:
the application ID indicates user plane requirements for the user device; and
mapping the application ID to the UPF ID comprises correlating, by the SMF, the user plane requirements for the user device to capabilities of the UPF.

4. The method of claim 3 wherein the capabilities of the UPF comprise low-latency capabilities.

5. The method of claim 3 wherein the capabilities of the UPF comprise high-throughput capabilities.

6. The method of claim 1 wherein the application ID comprises a Traffic Detection Functionality (TDF) application ID.

7. The method of claim 1 wherein the application ID comprises a subscriber attribute provisioned to the user device.

8. A system comprising:
a Session Management Function (SMF) configured to:
transfer a policy create request to a Policy Control Function (PCF) in response to a Protocol Data Unit (PDU) session create request for a user device received from an Access and Mobility Management Function (AMF);
receive a policy create response from the PCF for the policy create request;
parse the policy create response to determine an application Identifier (ID) for the user device;
map the application ID to a User Plane Function (UPF) ID;
select a UPF to serve the user device based on the mapping; and
transfer a session request to the UPF to establish a PDU session for the user device.

9. The system of claim 8 wherein the SMF is further configured to:
host a data structure that associates application IDs with UPF IDs;
compare the application ID to the data structure; and
select the UPF ID based on the comparison to map the application ID to the UPF ID.

10. The system of claim 8 wherein:
the application ID indicates user plane requirements for the user device; and the SMF is further configured to:
correlate the user plane requirements for the user device to capabilities of the UPF to map the application ID to the UPF ID.

11. The system of claim 10 wherein the capabilities of the UPF comprise low-latency capabilities.

12. The system of claim 10 wherein the capabilities of the UPF comprise high-throughput capabilities.

13. The system of claim 8 wherein the application ID comprises a Traffic Detection Functionality (TDF) application ID.

14. The system of claim 8 wherein the application ID comprises a subscriber attribute provisioned to the user device.

15. One or more non-transitory computer readable storage media having program instructions stored thereon, wherein the program instruction, when executed by a computing system, direct the computing system to perform operations, the operations comprising:
transferring a policy create request to a Policy Control Function (PCF) in response to a Protocol Data Unit (PDU) session create request for a user device received from an Access and Mobility Management Function (AMF);
receiving a policy create response from the PCF for the policy create request;
parsing the policy create response to determine an application Identifier (ID) for the user device;
mapping the application ID to a User Plane Function (UPF) ID;
selecting a UPF to serve the user device based on the mapping; and
transferring a session request to the UPF to establish a PDU session for the user device.

16. The one or more computer readable storage media of claim 15 wherein mapping the application ID to the UPF ID comprises hosting a data structure that associates application IDs with UPF IDs, comparing the application ID to the data structure, and selecting the UPF ID based on the comparison.

17. The one or more computer readable storage media of claim 15 wherein:
the application ID indicates user plane requirements for the user device; and
mapping the application ID to the UPF ID comprises correlating the user plane requirements for the user device to capabilities of the UPF.

18. The one or more computer readable storage media of claim 17 wherein the capabilities of the UPF comprise low-latency capabilities.

19. The one or more computer readable storage media of claim 17 wherein the capabilities of the UPF comprise high-throughput capabilities.

20. The one or more computer readable storage media of claim 15 wherein:
the application ID comprises a Traffic Detection Functionality (TDF) application ID; and
the TDF application ID comprises a subscriber attribute provisioned to the user device.
